(19) United States
(12) Patent Application Publication
(10) Pub. No.: US 2004/0023046 A1
(43) Pub. Date: Feb. 5, 2004

(54) Carrier substrate for Raman spectrometric analysis

(76) Inventors: Falko Schlottig, Fullinsdorf (CH); Norbert Meyer, Chemnitz (DE); Marcus Textor, Schaffhausen (CH); Ulrich Schnaut, Grasbrunn (DE); Jean-Francois Paulet, Siblingen (CH); Kurt Sekinger, Volketswil (CH)

Correspondence Address: BACHMAN & LAPOINTE, P.C., 900 CHAPEL STREET, SUITE 1201, NEW HAVEN, CT, 06510, US

(21) Appl. No.: 10/414,145

(22) Filed: Apr. 15, 2003

Related U.S. Application Data
(62) Division of application No. 09/762,324, filed on Feb. 2, 2001, now abandoned.

(30) Foreign Application Priority Data
Aug. 4, 1998 (EP) 98810748.8

(51) Int. Cl. B32B 9/00

(52) U.S. Cl. 428/469; 428/650; 428/364

(57) ABSTRACT

A process for surface-enhanced Raman spectrometric analysis of substances comprises the steps of providing substances to be analyzed, providing a carrier-layer with a multiplicity of nanobodies for receiving the substances to be analyzed, the multiplicity of nanobodies formed on at least one side of the carrier layer, whereby each nanobody has a rod-like stem area lying on the carrier layer and at least two branch elements formed on the stem area, and the density of the branch elements is a least 10⁸/cm²; locating the substances on the carrier layer; and irradiating the substances to provide a Raman scatter.

The present invention concerns a carrier substrate for surface-enhanced Raman spectrometric analysis of substances, comprising a carrier layer and a multiplicity of nanobodies formed at least on one side of the carrier layer. The invention also concerns a process for production of a carrier substrate for surface-enhanced Raman spectrometric analysis of substances, comprising a carrier layer and a multiplicity of nanobodies formed on the carrier layer each with at least one end tip, where each nanobody has a maximum cross sectional diameter of between 10 and 250 nm and a height of 30 nm to 5 μm and the density of the end tips is at least 10⁸/cm².

Raman spectrometry is used for qualitative and quantitative chemical analysis of substances. A substance is irradiated with an intensive monochromatic electromagnetic radiation, for example laser light. Normally, electromagnetic radiation from the visible or ultraviolet spectrum range is used. The substances to be tested can take the form of a gas, a liquid or a solid. When measuring the scattered light with a spectrograph i.e. when determining the radiation intensity of the scattered light as a function of wavelength, a spectrum is obtained which consists of a strong line known as the exciter line and very many weaker lines known as the Raman lines on either side of the strong line. The exciter line has the same wave number as the incident radiation. The Raman lines correspond in each case to specific rotation or oscillation states of the substance to be tested. The Raman lines are arranged symmetrically on a wave number scale in relation to the exciter line. The Raman lines also have an intensity typically 10⁻³ to 10⁻⁴ times lower than the exciter line, where the intensity of the Raman lines on the low frequency side is substantially greater in relation to those on the high frequency side.

The frequency differences between the Raman lines and the exciter line are independent of the frequency of the exciter line. However, the intensity of the scatter radiation depends greatly on the frequency of the exciter radiation.

The Raman spectrum, i.e. the sequences of Raman lines, are characteristic for each substance. A compound can be identified by comparison of its Raman spectrum with the spectra of suitable known compounds. Comprehensive systematically arranged spectrum compilations are available for this. The quantitative analysis is based on the measurement of the intensities of Raman lines of the substance to be determined, where the intensity is proportional to the concentration of the substance. Also structural analyses can be carried out with Raman spectrometry as structural constituents of molecules such as carbonyl, hydroxyl or methyl groups each have characteristic group frequencies.

The Raman spectra cover the rotation and oscillation frequencies of the substance constituents so that from this can be obtained information on polarizability, chemical bonding forces and atomic distances in the molecules. The Raman lines arise from the non-elastic scatter of light quanta on the molecules where the molecules are stimulated, or stimulated molecules transform to a state of lower energy. The Raman lines occur when the polarizabilities change on oscillation and rotation.

A main difficulty with Raman spectrometry is the low intensity of the Raman lines. This difficulty can be reduced for example by the use of high energy lasers or the use of large quantities of the substance to be tested. The use of a high energy laser, as well as the necessary high investment costs, also has the disadvantage that delicate substances can be damaged, or the substance to be tested can change due to the high energy supplied into its structure by a high power laser, for example by chemical reactions such as combustion.

In a special variant of Raman spectrometry known as surface-enhanced Raman spectrometry (SERS) or surface-enhanced resonance Raman spectroscopy (SERRS), for certain constructions of carrier substance surfaces a significant increase is observed in the intensity of the Raman lines of the substances adsorbed on the carrier surface, for example molecules. The increase in intensity of the Raman scatter in surface-enhanced Raman spectroscopy, compared with Raman spectroscopy without surface enhancement, is of the order of 10⁶. The effect of the increase in scatter intensity depends greatly on the roughness and spatial formation of the roughness structure on the carrier substrate surface.

Surface-enhanced Raman scatter is essentially based on a roughness structure with nanobodies i.e. a carrier substrate surface with submicron structural elements. The submicron structural elements have dimensions in the submicrometer range. On irradiation of the substance adsorbed onto the structural elements with an electromagnetic exciter radiation, due to the electronic and/or chemical interactions between the adsorbate, i.e. the substance to be tested, and the carrier substrate surface with the nanobodies, submicron structural elements can lead to an increase in local field strength. Consequently, the interaction which leads to the surface-enhanced Raman scatter depends firstly on the structural and material formation of the carrier substrate surface and secondly on the electronic structure of the substance adsorbed onto this. The interaction leading to the surface-enhanced Raman scatter can be described firstly by a conventional electromagnetic enhancement which is described by the increase in amplitude of the local electromagnetic field and normally causes the majority of the enhancement, and secondly by a chemical enhancement which reinforces the interaction in a first mono-position of the adsorbed substance, where in this first mono-position charges can be transferred between the substance and the carrier substrate.

Surface-enhanced Raman scatter is also dependent on the exciter radiation used, and on the ratio of nanobody dimensions to the wavelength of the exciter radiation. To achieve a maximum intensity of the Raman lines, the density of the nanobodies on the carrier substrate must also be as high as possible. Also, the entirety of nanobodies must have optimum size distribution. With optimum selection of the said parameters maximum interaction is achieved between the substance adsorbed on the carrier substrate surface and the electromagnetic exciter radiation.

EP 0 484 425 B1 describes a carrier substrate for surface-enhanced Raman spectrometry which comprises a cohesive dielectric roughness layer with a thickness of at least 170 nm deposited on a substrate and a second layer deposited throughout on this first layer, the second layer having a multiplicity of metal needles where the metal needles have a length of at least 350 nm and a width of at least 50 nm, and the density of the metal needles is at least 70.10⁸/cm². Furthermore, EP 0 484 425 B1 discloses a process for production of such carrier substrates where the dielectric layer and the second layer with the metal needles are deposited by vacuum deposition on the substrate surface. The metal needles are formed by vapour-deposition of the metal onto the dielectric layer at a particular angle and with a specified rate.

The task of the present invention is to provide carrier substrates for surface-enhanced Raman spectrometry which are easier to produce than the state of the art and which also achieve a higher proportion of surface-enhanced Raman scatter.

According to the invention this task is solved in that each nanobody has a rod-like stem area at the carrier surface and at least two, preferably 2 to 4, branch elements formed on the stem area, and the density of the branch elements is at least 10⁸/cm².

The nanobodies are formed on at least one side of the carrier layer. Preferably, however, all nanobodies lie on the same side of the carrier layer. The nanobodies also preferably have, at least in a part projecting from the carrier layer, a stem area lying orthogonal to the carrier layer. Particularly preferred are nanobodies whose entire rod-like stem area lies orthogonal to the carrier layer surface.

The nanobodies preferably have a maximum cross sectional diameter between 10 and 250 nm, in particular between 10 and 150 nm, and a height of 30 nm to 5 μm, in particular 30 nm to 2 μm. The height of the individual nanobodies preferably varies by no more than ±5%, in particular by no more than ±3% of the mean height of all nanobodies, where the height of a nanobody is the maximum dimension of the nanobody measured orthogonal to the surface of the carrier layer i.e. the stem area together with the formed branch elements.

Preferably, the nanobodies are distributed substantially over the entire surface of one side of the carrier layer. The distribution of the nanobodies is preferably homogenous. The density of the branch elements projecting from the stem areas of the nanobodies is suitably at least 10⁸/cm². Also, preferably the carrier substrates according to the invention have a branch element density of 10⁸ to 10¹²/cm².

In a further preferred embodiment 95% of all branch elements have an even height, where even height means that these deviate by no more than ±5% from the mean height of the branch elements on the entire substrate. The height of the branch elements is the maximum dimension of the branch elements measured orthogonal to the surface of the carrier layer.

The nanobodies and/or carrier layer consist for example of Ni, Al, Pd, Pt, W, Fe, Ta, Rh, Cd, Cu, Au, Ag, In, Co, Sn, Si, Ge, Te, Se or a chemical compound containing at least one of these substances, such as for example Sn or InSn oxide, or an alloy of the said metals. Also, the carrier layer and/or the nanobodies can consist of one of the said materials where in addition a metal layer, in particular of Au or Ag, can be deposited. Preferably, the nanobodies and the carrier layer consist of the same material. Particularly preferably, the carrier layer and the nanobodies consist of Au or Ag.

In a further preferred embodiment, the carrier layer has between the nanobodies a mechanical supporting layer consisting of a material, preferably an oxide and in particular an aluminium oxide. Suitably, the layer thickness of the mechanical supporting layer measures less than the mean height of the stem areas of all nanobodies over the entire carrier layer and in particular less than half of this mean height of the stem areas.

The carrier substrates according to the invention are ideal for surface-enhanced Raman spectrometry as the individual branch elements and the stem areas of the nanobodies can serve as submicron structural elements enhancing the Raman scatter and the resulting very high number of submicron structural elements greatly increases the intensity of the Raman lines i.e. by more than a factor of 10⁶, in comparison with the Raman spectrometry without surface enhancement.

A further task of the present invention is to propose a simpler and cheaper process than the state of the art for production of known carrier substrates for surface-enhanced Raman spectrometric analysis of substances and to provide a process for production of the carrier substrate according to the invention.

The task relating to the process is solved according to the invention in that:

a) in a first step a mould body with a mould body surface mirror-inverted to the required carrier substrate surface is created in that a substrate body of an anodisable metal is oxidised anodically in an electrolyte redissolving the metal oxide concerned, whereby at least on one substrate body surface is formed a mould layer of metal oxide comprising a barrier layer adjacent to the substrate body surface and a porous layer lying on this, and the porous layer contains the pore cavities formed mirror-inverted to the required nanobodies;

b) in the second step the mould body surface is coated throughout by chemical and/or electrolytic methods such that the pore cavities are completely filled with a coating material and also a carrier layer connecting the pore cavities is formed from a coating material, and the carrier layer constitutes a cohesive mechanically supportive surface;

c) and in a third step the mould body is removed such that at least the end tips are exposed.

The mould body necessary for the production according to the invention of carrier substrates for surface-enhanced Raman spectrometric analysis of substances, with a mould body surface substantially mirror-inverted to the required carrier substrate surface, suitably consists of a substrate body and a mould layer where the latter contains the surface structure substantially mirror-inverted to the required carrier substrate surface.

The substrate body preferably consists of aluminium or aluminium alloy and preferably constitutes a part of a piece, for example a profile, bar or other piece, a plate, a strip, a panel or an aluminium foil, or an aluminium cover layer of a laminate, in particular an aluminium cover layer of a laminated panel, or concerns an aluminium layer applied to any material—for example electrolytically—such as for example a plated aluminium coating. Also, preferably the substrate body is a workpiece of aluminium which is produced for example by rolling, extrusion, forging or pressing. The substrate body can also be formed by bending, deep drawing, cold extrusion or similar.

In the present text the material aluminium comprises aluminium of all degrees of purity and all commercial aluminium alloys. For example the term aluminium includes all rolled, wrought, cast, forged and pressed alloys of aluminium. Suitably the substrate body consists of pure aluminium with a purity equal to or greater than 98.3 w. % or aluminium alloys with at least one of the elements from the series Si, Mg, Mn, Cu, Zn or Fe. The substrate body of pure aluminium can for example consist of aluminium of a purity of 98.3 w. % or higher, suitably 99.0 w. % and higher, preferably 99.9 w. % and higher and in particular 99.95 w. % and higher, the remainder being normal commercial contaminants.

In addition to aluminium of the said purities the substrate body can consist of an aluminium alloy containing 0.25 w. % to 5 w. %, in particular 0.5 to 2 w. %, magnesium or containing 0.2 to 2 w. % manganese or containing 0.5 to 5 w. % magnesium and 0.2 to 2 w. % manganese, in particular e.g. 1 w. % magnesium and 0.5 w. % manganese, or containing 0.1 to 12 w. %, preferably 0.1 to 5 w. %, copper or containing 0.5 to 5 w. % zinc and 0.5 to 5 w. % magnesium or containing 0.5 to 5 w. % zinc, 0.5 to 5 w. % magnesium and 0.5 to 5 w. % copper or containing 0.5 to 5 w. % iron and 0.2 to 2 w. % manganese, in particular e.g. 1.5 w. % iron and 0.4 w. % manganese.

The mould layer consists preferably of aluminium oxide. The mould layer necessary for the process according to the invention is preferably produced by anodic oxidation of the substrate body surface in an electrolyte under pore-forming conditions. It is essential to the invention that the pores are open towards the free surface. Advantageously, the pore distribution over the surface is even. The layer thickness of the mould layer is suitably 50 nm to 5 μm and preferably 50 nm to 2 μm.

The mould layer is produced for example by anodic oxidation of the substrate body surface in an electrolyte which redissolves the aluminium oxide. The electrolyte temperature is suitably between −5 and 85° C., preferably between 15 and 80° C. and in particular between 30 and 70° C. To perform the anodic oxidation the substrate body or at least its surface layer, or at least the part of the substrate body surface to be given the mould layer, is placed in a corresponding electrolyte and switched as the positive electrode (anode). The negative electrode (cathode) is another electrode placed in the same electrolyte and consisting for example of stainless steel, lead, aluminium or graphite.

Usually, the substrate body surface is subject to pretreatment before the process according to the invention, where for example the substrate body surface is first degreased then rinsed and finally pickled. Pickling is for example carried out with a sodium hydroxide solution with a concentration of 50 to 200 g/l at 40 to 60° C. for one to ten minutes. The surface can then be rinsed and neutralised with an acid for example nitric acid, in particular at a concentration of 25 to 35 w. % at room temperature i.e. typically in the temperature range 20-25° C. for 20 to 60 seconds and then rinsed again.

The properties of an oxide layer produced by anodic oxidation, such as for example the pore density and the pore diameter, largely depend on the anodising conditions such as for example the electrolyte composition, electrolyte temperature, current density, anodising voltage and anodising duration, and the basic material anodised. During anodic oxidation in acid electrolyte a substantially pore-free base or barrier layer is formed on the substrate body surface and a porous outer layer which is partly chemically redissolved by redissolution during anodic oxidation at its free surface.

This creates pores in the outer layer, which lie substantially perpendicular to the substrate body surface and are open towards the free surface of the oxide layer. The thickness of the oxide layer reaches its maximum value when growth and redissolution are balanced, which for example depends on the anodising voltage applied, the electrolyte composition, the current density, the electrolyte temperature, the anodising duration and the basic material anodised.

For performance of the process according to the invention, preferably electrolytes are used which contain one or more inorganic and/or organic acids. Also preferred are anodising voltages of 10 to 100 V and current densities of 50 to 3000 A/m². The anodising duration is typically 1 to 1000 s, suitably 1 to 240 s, in particular 1 to 20 s.

The anodising voltage is applied for example by a continuous increase of the applied voltage to a predetermined temporally constant value in each case. The current density is also increased as a function of the anodising voltage applied, temporally reaches a maximum value after reaching the predetermined constant voltage and then slowly diminishes.

The layer thickness of the barrier layer is voltage-dependent and lies for example in the range from 8 to 16 Angström/V and in particular between 10 and 14 Angström/V. The pore diameter of the porous outer layer is also voltage-dependent and for example is between 8 and 13 Angström/V and in particular 10 to 12 Angström/V.

The electrolyte can for example contain a strong organic or inorganic acid or a mixture of strong organic and/or inorganic acids. Typical examples of such acids are sulphuric acid (H₂SO₄) or phosphoric acid (H₃PO₄). Other acids which can be used are for example chromic acid, oxalic acid, sulphamic acid, malonic acid, maleic acid or sulphosalicylic acid. Mixtures of the said acids can also be used. For the process according to the invention for example sulphuric acid is used in quantities of 40 to 350 g/l and preferably 150 to 200 g/l (sulphuric acid in relation to 100% acid). As electrolyte phosphoric acid can be used in a quantity of 60 to 300 g/l and in particular 80 to 150 g/l where the acid quantity is in relation to 100% pure acid. Another preferred electrolyte is sulphuric acid mixed with oxalic acid, where in particular a quantity of 150 to 200 g/l sulphuric acid is mixed for example with 5 to 25 g/l oxalic acid. Also preferred are electrolytes containing for example 250 to 300 g/l maleic acid and for example 1 to 10 g/l sulphuric acid. A further electrolyte contains for example 130 to 170 g/l sulphosalicylic acid in a mixture with 6 to 10 g/l sulphuric acid.

For production of the carrier substrates according to the invention which contain several branch elements, the oxidation of the substrate body surface to be performed in the first process step takes place in several anodising steps, where in a first anodising step the anodising voltage is increased continuously or in stages from 0 to a first value U₁ and in a further, for example second, anodising step the anodising voltage is reduced continuously or in stages to a second value U₂ lower than U₁. Preferably, the anodising voltage, for the formation of cylindrical or truncated conical, long pore stem areas, is set to a first value U₁ between 12 and 80 V and then, for the formation of at least two pore branches per pore stem area at the end of each pore directed towards the substrate surface, reduced to a second value U₂ between 10 and 20 V.

In their vertical extension the pores have a stem area directed towards the surface of the mould layer and a branch area directed towards the substrate body, i.e. each pore lying substantially perpendicular to the surface of the mould layer consists of a linear pore open towards the free surface of the mould layer and dividing in the branch area into at least two, preferably 2 to 4, recesses or pore branches.

Suitably, in the stem area the pores have a diameter of 10 to 250 nm, preferably between 10 and 150 nm and in particular between 40 and 130 nm. The pore count, i.e. the number of pores in the stem area, is suitably 10⁸ pores/cm² or higher, preferably 10⁸ to 10¹² pores/cm² and in particular 10⁹ to 10¹¹ pores/cm². The mean density of the mould layer is preferably 2.1 to 2.7 g/cm³. Also, preferably the mould layer has a dielectric constant of between 5 and 7.5.

After the anodising process the surface of the mould layer can be passed for further treatment e.g. chemical or electrolytic etching, plasma etching, rinsing or impregnation.

The finished mould layer is coated over the entire surface such that the pore cavities present in the porous layer of the mould body are completely filled with the coating material, and a carrier layer is formed connecting the nanobodies, and the carrier layer constitutes a cohesive, mechanically supporting layer.

For coating the mould body surface, for example Ni, Al, Pd, Pt, W, Fe, Ta, Rh, Cd, Cu, Au, Ag, In, Co, Sn, Si, Ge, Se, Te can be used, or a chemical compound containing at least one of these elements, or an alloy of the above metals. Metallic coating materials are preferred, in particular coatings of Au or Ag.

The mould body surface can for example be coated by chemical or electrolytic methods or by PVD (physical vapour deposition) or CVD (chemical vapour deposition). A chemical and/or electrolytic deposition of the coating material is preferred, where suitably the pore cavities are previously chemically activated.

Preferably, the coating of the mould body surface to be performed in the second process step takes place in three stages, where in a first stage the mould body surface and in particular the pore cavities are seeded with coating material electrolytically, in a second stage by a current-free chemical deposition the pore cavities are completely filled with coating material and chemical deposition of coating material continues until a layer of 100 nm to 2 μm of coating material is formed on the mould body surface lying between the pore cavities, and in a third stage the coating is reinforced galvanically until a coating layer thickness of 10 to 20 μm results.

As a further process stage essential to the invention, the nanobodies, in particular their branch elements, are exposed by complete or partial removal of the mould layer.

The complete exposure of the nanobodies, i.e. the separation of the carrier layer with the formed nanobodies from the mould body, can for example take place by complete etching away of the mould body. In a preferred embodiment, however, only the mould layer is chemically etched away so that the carrier layer with the formed nanobodies is fully separated from the mould body and thus present in the form of a carrier substrate according to the invention.

In a further preferred embodiment only part of the mould layer is etched away so that on the carrier layer between the stem areas of the nanobodies the mould layer remains and forms a mechanical supporting layer. This takes place for example by chemical etching of the substrate body, the barrier layer and part of the porous layer. The porous part of the mould layer must however be removed so that the branch elements of the nanobodies are totally exposed.

In a further preferred embodiment of the process according to the invention the exposed nanobodies are subjected to an etching process, for example by plasma etching or chemical or electrolytic etching. Thus, for example the shape of the branch elements and/or the stem areas can be optimised with regard to surface-enhanced Raman spectroscopy.

Furthermore, as part of secondary treatment of the nanobodies according to the invention, an additional thin metal layer can be deposited which modifies the structure of the nanobodies and the branch elements such that their properties are optimised for surface-enhanced Raman spectrometry of a certain substance to be tested. This additional thin metal layer preferably consists of a noble metal, in particular Au or Ag. The deposition of this additional metal layer can take place for example by chemical or electrolytic methods, PVD (physical vapour deposition), for example sputtering or electron beam vaporisation, or by CVD (chemical vapour deposition).

Further advantageous developments of the invention are described in the sub-claims.

The process according to the invention allows the low cost production of carrier substrates for surface-enhanced Raman spectrometric analysis of substances. The process allows in particular the reproducible production of such carrier substrates in large quantities and constant quality.

Design examples for the production of carrier substrates according to the invention are described below. All data in parts or percentages relate to the weight unless specified otherwise.

### FIRST DESIGN EXAMPLE

The substrate body is an aluminium panel with 99.9 w. % Al with bright surface. The aluminium panel is cleaned in a mild alkali degreasing solution, rinsed in water, pickled in nitric acid, rinsed in water, briefly immersed in ethanol and dried.

Then on the back of the panel a suitable cover lacquer is applied and the substrate body pretreated in this manner is anodised for 10 seconds in a phosphoric acid electrolyte with a concentration of 155 g/l H₃P0₄ at an electrolyte temperature of 68° C. with direct current at a density of 12 A/dm² and an anodising voltage of 20 V. The resulting layer thickness of the aluminium oxide layer is typically 100 nm.

The mould layer, i.e. the aluminium oxide layer, now has pores which have a stem area open at the top projecting from the free surface of the aluminium oxide layer.

The mould body, i.e. in particular the free surface of the mould layer, is now rinsed with water and treated for 5 to 10 seconds in an activation bath containing aurate (1 g/l H(AuCl₄)*3 H₂O, 7 g/l H₂SO₄) with an applied alternating voltage of 16 V, and then rinsed with water again.

The pores of the moulding layer prepared in this way have gold particles included in the pore base which serve preferably as seeds for further selective gold deposition. The selective gold deposition, i.e. the further deposition of gold on the gold particles already in the pores, takes place primarily by the chemical route in a gold bath (gold bath: Aruna® 516 by Degussa containing 4 g/l Au, pH 7.5) at a temperature of 70° C. The selective gold deposition takes around 2 hours where a gold layer with a thickness of approx 2 μm is generated. The mould layer to which the gold is applied is now rinsed again with water and the gold layer is then reinforced to around 10 μm Au in a commercial galvanic gold bath (gold bath: Aruna® 552 by Degussa containing 8 g/l Au, pH6) with a current density of 0.4 A/dm².

After further water rinsing of the mould body coated with gold, the cover lacquer is removed for example chemically or by plasma etching. The mould body is now dissolved chemically in sodium lye (50 g/l NaOH). At an NaOH bath temperature of around 40° C. this process takes several hours, typically around 12 hours.

After removal of the mould body, the required carrier substrate with nanobodies remains, where the nanobodies substantially have the same dimensions as the pore cavities previously present in the mould layer.

The carrier substrate is again rinsed with water, pickled for 10 minutes in 5% citric acid at 20° C., rinsed with water again, dipped in ethanol and then dried.

If a carrier substrate produced in this manner is used for surface-enhanced Raman spectroscopic analysis of aniline, where the exciter radiation is the 632.8 nm line of a helium ion laser and the laser power is 8 mW, a Raman spectrum is obtained which shows the typical Raman lines for aniline on gold.

### SECOND DESIGN EXAMPLE

An aluminium panel as described in the first example serving as a substrate body is cleaned in the manner described in the first example.

Then on the back of the panel is applied a suitable cover lacquer, and the substrate body pretreated in this way is anodised for 6 minutes in a phosphoric acid electrolyte with a concentration of 150 g/l H₃PO₄ at an electrolyte temperature of 35° C. with direct current at a density of 120 A/m², where the anodising voltage is increased continuously from 0 to 50 V. Immediately afterwards the anodising voltage is reduced to around 15 V in 5 to 6 stages where the voltage reduction stages are initially small and gradually increased. After reaching the anodising voltage of around 15 V, this is maintained for around 30 seconds. The resulting layer thickness of the aluminium oxide layer is typically 600 nm.

The mould body i.e. the anodised substrate body now has pores which have a stem area open at the top projecting towards the free mould body surface and a branch area directed towards the substrate body.

The mould body i.e. the free surface of the mould layer is now rinsed with water and treated for 5 to 10 seconds in an activation bath containing aurate (1 g/l H(AuCl₄)*3 H₂O, 7 g/l H₂SO₄) with an applied alternating voltage of 16 V and then rinsed with water again.

The selective gold deposition takes place chemically and then galvanically as described in the first example. After a water rinsing process the cover lacquer is removed according to the first example, the mould body chemically dissolved and thus the required gold carrier substrate exposed.

As described in the first application example, the carrier substrate produced in this way with metal nanobodies is used for surface-enhanced Raman spectrometric analysis of aniline where the Raman spectrum of this selected system is taken with the 632.8 nm line of a helium ion laser. The laser power is 8 mW. The spectra obtained show the typical Raman lines for aniline on gold.

### THIRD DESIGN EXAMPLE

An aluminium panel as described in the first example serving as a substrate body is cleaned and anodised according to the processes described in the first or second design examples. The mould body formed in this way is activated according to the first design example.

The selective gold deposition takes place chemically and then galvanically as described in the first example. After a water rinsing process the cover lacquer is removed in accordance with the first example, the mould body chemically dissolved and thus the required carrier substrate exposed.

The metal nanobodies of the carrier substrate are now subjected to an electrolytic secondary treatment where the diameter and length or height of the nanobodies is reduced. For this secondary treatment the carrier substrate is placed in a suitable holder and treated for 10 seconds in 1 M H₂SO₄ with 300 μA/cm², then rinsed with water and treated for 1 minute in 5 M NHl. The treated carrier substrate is then rinsed with water again.

As described in the first and second application examples, the carrier substrate with the metal nanobodies produced in this way was tested for the surface-enhanced Raman spectrometric analysis of aniline, where the Raman spectra of this selected system are recorded with the 632.8 nm line of a helium ion laser. The laser power was 8 mW. The spectra obtained again show the typical Raman lines for aniline on gold.

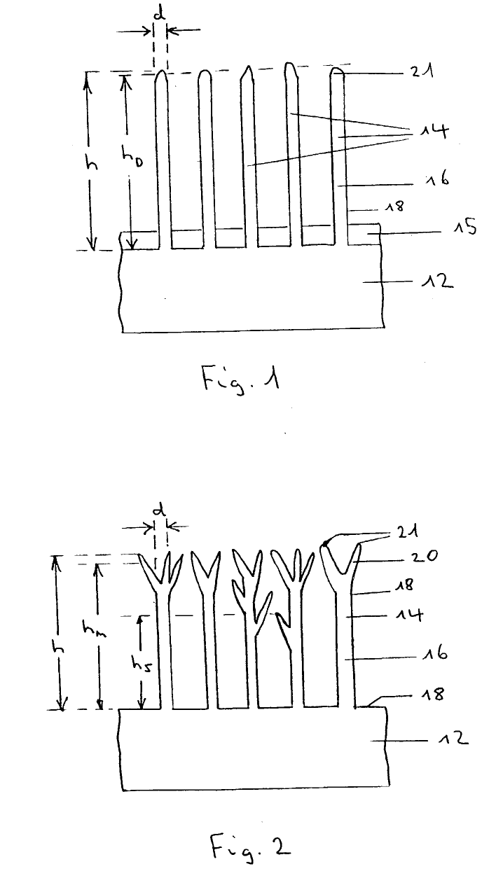

The present invention is explained using the example shown in FIGS. 1 to 6.

FIG. 1 shows diagrammatically a cross section of a carrier substrate produced in the process according to the invention for surface-enhanced Raman spectrometric analysis of substances. The carrier substance comprises a carrier layer 12 on which is formed on one side a multiplicity of nanobodies 14. The nanobodies shown in FIG. 1 have a stem area 16 leading orthogonally away from the carrier sublayer, which in each case runs to a single end tip 21 at its free end. The individual nanobodies 14 have a height h and maximum cross sectional diameter d, where the cross sectional diameter d of the nanobody stem areas 16 remains substantially constant as a function of the height, i.e. the nanobody stem areas 16 are substantially formed rod-like. All nanobodies 14 have substantially the same height h. Here h_{D} indicates the mean height of the nanobodies determined from all nanobodies 14. In the embodiment shown in FIG. 1 between the nanobodies 14 is another mechanically supporting layer 15 deposited on the carrier layer 12, which supports the mechanically unstable, long thin nanobodies 14. The carrier substrate surface 18 concerns firstly the surface of the nanobodies 14 and the surface of the carrier layer 12 lying between the nanobodies 14 which however in FIG. 1 is covered by the mechanical supporting layer 15.

FIG. 2 shows diagrammatically a cross section of a carrier substrate according to the invention for the surface-enhanced Raman spectrometric analysis of substances. The carrier substrate contains a carrier layer 12. On one side of the carrier layer 12 is formed a multiplicity of nanobodies 14. The nanobodies in each case have a rod-like stem area 16 and at least two branch elements 20 formed on the stem area 16. The two nanobodies 14 shown on the outside left in FIG. 2 and the outside nanobody 14 on the right-hand side of FIG. 2 show for example branch elements 20 formed at the end of stem area 16. The remaining nanobodies shown in FIG. 2 have, as well as the branch elements 20 formed at the end of the stem area 16, further branch elements 20 not formed at the end of the stem area. Each branch element 20 at its free end has a tip 21.

The height of the individual nanobodies 14 is given again in FIG. 2 as h and the maximum cross sectional diameter of each nanobody 14 as d. The maximum cross sectional diameter of each nanobody 14 lies in the stem area 16, where the stem area 16 is formed rod-like to slightly truncated conical so that the largest maximum cross sectional diameter d is usually measured in the area of the nanobody 14 close to the carrier layer. The carrier substrate surface 18 again indicates the entire surface of the carrier substrate on the carrier layer side which contains the nanobodies 14. Consequently, the carrier substrate surface 18 includes firstly the carrier layer surface lying between the nanobodies 14 and secondly the entire surface of the nanobodies 14, i.e. their surface with regard to their stem area 14 and the branch elements 20.

The maximum height of the individual branch elements 20, i.e. the maximum distance of the end tip 21 of a branch element 20 from the carrier substrate surface 18 lying between the nanobodies 14 is marked hₛ. The mean height hₛ of all branch elements 20 determined over all nanobodies 14 present on the carrier layer 12 is marked hₘ.

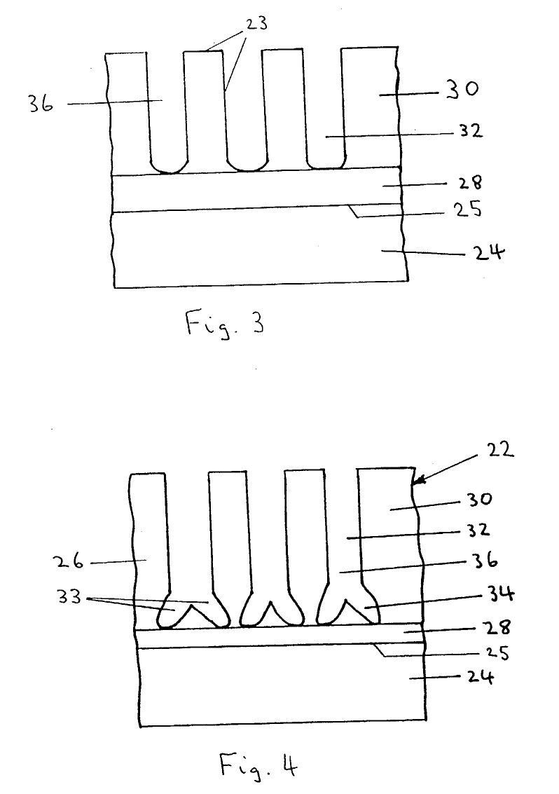

FIG. 3 shows diagrammatically a cross section through a mould body 22 produced in the process according to the invention. The mould body 22 consists of the substrate body 24 and a mould layer 26, where the mould layer 26 is composed of a porous layer 30 and a barrier layer 28. The barrier layer 28 lies on one side of the substrate body 24 known as the substrate body surface 25. The porous layer 30 contains the pore cavities 36 where the pore cavities 36 shown in FIG. 3 have a cylindrical shape. The exposed surface of the mould layer 26 describes the mould body surface 23 which is defined on one side by the surface of the pore cavities 36 and on the other side by the exposed surface of the porous layer 30 between the pore cavities 36.

A mould body 22 formed according to FIG. 3 occurs for example after an anodic oxidation of a metal substrate body surface 25 with an anodising voltage increasing constantly or continuously or in stages in an electrolyte redissolving the metal oxide.

FIG. 4 shows diagrammatically a cross section through a mould body 22 obtained in the process according to the invention, in which—starting from a mould body 22 according to FIG. 3—the anodic oxidation of the substrate body surface 25 is continued with an anodising voltage lower than before, i.e. for the production of the pore cavities according to FIG. 3.

The pore cavities 36 shown in FIG. 4 present in the porous layer 30 have a pore stem area 32 open at the top and lying perpendicular to the substrate body surface 25, and a pore branch area 33 lying on the barrier layer 28. The pores shown each have in the branch area 33 two pore branches 34.

A mould body produced according to FIG. 4 occurs for example if—starting from a mould body 22 according to FIG. 3—the anodic oxidation is continued with a lower anodising voltage. For this the anodising voltage—starting from the anodising voltage applied for production of the cylindrical pore cavities 32, 36—can be lowered in stages or continuously. As the pore diameter forming during the anodic oxidation and the thickness of barrier layer 28 depend on the level of the anodising voltage, during such a second process stage the thickness of the barrier layer 28 diminishes, where the layer thickness of the porous oxide layer 30 grows further. As the formation of the oxide layer 28, 30 occurs at the interface between the aluminium substrate body 24 and the barrier layer 28, and the pore diameter is dependent on the anodising voltage, at the pore stem area 32 are then formed several pore branches 34 with a diameter smaller than the stem area 32.

FIG. 5 shows diagrammatically the cross section through a mould body 22 obtained in the process according to the invention and covered with coating material. The mould body 22 consists of a substrate body 24 and a mould layer 26. The porous layer 30 of the mould layer 26 contains pores, the pore cavities 36 of which have a stem area 32 and a branch area 33 with at least two pore branches 34. The pore cavities 36 are totally filled with coating material. The coating material in the pore cavities 36, after removal of the mould layer 26, forms the nanobodies 14 of the carrier substrate. Also on the moulding layer 26 is a complete layer of coating material which binds the coating material present in pore cavities 36 and which forms the carrier layer 12 after exposure of the carrier substrate.

A mould body 22 formed according to FIG. 5 and provided with coating material occurs for example if—starting from a mould body 22 according to FIG. 4—the mould body surface 23 is activated chemically and/or electrolytically and then the coating material deposited by chemical and/or electrolytic process.

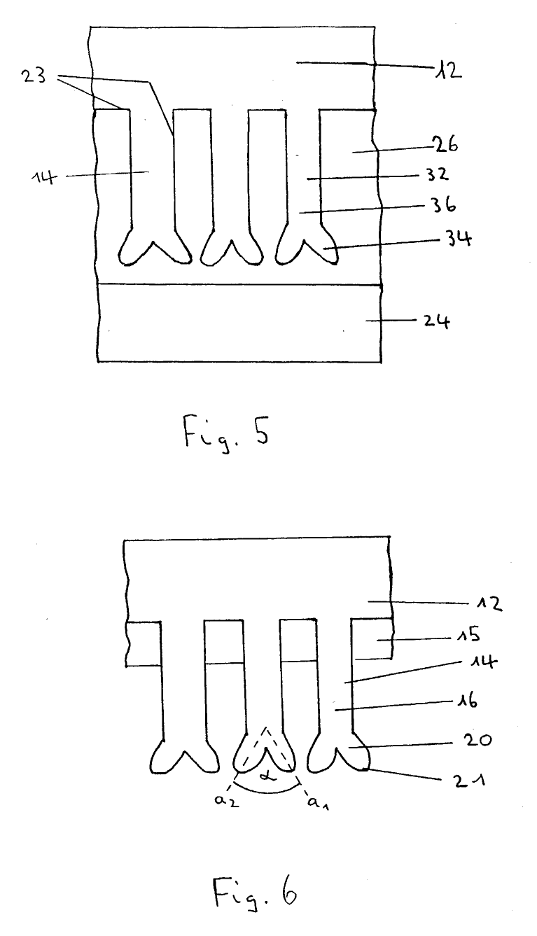

FIG. 6 shows diagrammatically the cross section through a carrier substrate produced in the process according to the invention for surface-enhanced Raman spectrometric analysis of substances. The carrier substrate has a carrier layer 12 and on one side of the carrier layer 12 a multiplicity of nanobodies 14. The nanobodies 14 shown in FIG. 6 have a stem area 16 and in each case two branch elements 20, the longitudinal axes a₁, a₂ of which enclose an acute angle α. Also each branch element 20 at the exposed end has a tip 21. The stem area 16 of the nanobodies 14 are supported mechanically by a supporting layer 15 lying between these, where some of the stem areas 16 and the branch elements 20 are exposed.

A carrier substrate formed according to FIG. 6 occurs for example if—starting from a moulded body 22 with a coating material according to FIG. 5—the substrate body 24 and part of the moulding layer 26 are chemically etched away.

1. Carrier substrate for surface-enhanced Raman spectrometric analysis of substances, comprising a carrier layer (12) and a multiplicity of nanobodies (14) formed on at least one side of the carrier layer (12), characterised in that each nanobody (14) has a rod-like stem area (16) lying on the carrier layer (12) and at least two, preferably 2 to 4, branch elements (20) formed on the stem area (16), and the density of the branch elements (20) is at least 10⁸/cm².

2. Carrier substrate according to claim 1, characterised in that each nanobody (14) has a maximum cross sectional diameter (d) between 10 and 250 nm, in particular between 10 and 150 nm, and a height (h) of 30 nm to 5 μm, in particular 30 nm to 2 μm.

3. Carrier substrate according to claim 1 or 2, characterised in that the height (h) of the individual rod-like nanobodies (14) varies by no more than ±3% of the mean height (h_{D}) determined from all rod-like nanobodies (14).

4. Carrier substrate according to any of claims 1 to 3, characterised in that the density of the branch elements (20) is 10⁸ to 10¹²/cm².

5. Carrier substrate according to any of claims 1 to 4, characterised in that 95% of all branch elements (20) have an even height (hₛ), where an even height (hₛ) means that the height (hₛ) varies by no more than ±5% of the height (hₘ) of the branch elements (20) averaged over the entire substrate.

6. Carrier substrate according to any of claims 1 to 5, characterised in that the nanobodies (14) and the carrier layer (12) consist of the same material, preferably metal, in particular gold or silver.

7. Process for production of a carrier substrate for surface-enhanced Raman spectrometric analysis of substances, comprising a carrier layer (12) and a multiplicity of nanobodies (14) formed on the carrier layer (12) each with at least one end tip (21), where each nanobody (14) has a maximum cross sectional diameter (d) between 10 and 250 nm and a height (h) of 30 nm to 5 μm and the density of the end tips (21) is at least 10⁸/cm², characterised in that
a) in a first step a mould body (22) with a mould body surface (23) mirror-inverted to the required carrier substrate surface (18) is created in that a substrate body (24) of an anodisable metal is oxidised anodically in an electrolyte redissolving the metal oxide concerned, whereby at least on one substrate body surface (25) is formed a mould layer (26) of metal oxide comprising a barrier layer (28) adjacent to the substrate body surface (25) and a porous layer (30) lying on this, and the porous layer (30) contains pore cavities (36) formed mirror-inverted to the required nanobodies (14);
b) in a second step the mould body surface (23) is coated throughout by chemical and/or electrolytic methods such that the pore cavities (36) are completely filled with a coating material and also a carrier layer (12) connecting the pore cavities (36) is formed from a coating material, and the carrier layer (12) constitutes a cohesive mechanically supportive layer;
c) and in a third step the mould body (22) is removed such that at least the end tips (21) are exposed.

8. Process according to claim 7, characterised in that the substrate body (24) consists of aluminium or an aluminium alloy.

9. Process according to claim 7 or 8, characterised in that the oxidation of the substrate (24) to be performed in the first process step takes place in several anodising steps, where in a first anodising step the anodising voltage is increased continuously or in stages from 0 to a first value U₁ and in a further anodising step the anodising voltage is reduced continuously or in stages to a second value U₂ lower than U₁.

10. Process according to claim 9, characterised in that to form cylindrical or truncated conical long pore stem areas (32), the first value U₁ of the anodising voltage f lies between 12 and 80 V and the second value U₂ of the anodising voltage is between 10 and 20 V to form at least two pore branches (34) per pore stem area (32) on the end of each pore (36) directed towards the substrate body surface (25).

11. Process according to any of claims 7 to 10, characterised in that the coating of the mould body surface (23) to be performed in the second process step takes place by chemical and/or electrolytic methods.

12. Process according to claim 11, characterised in that the coating of the mould body surface (23) to be performed in the second process step takes place in three stages, where in a first stage the mould body surface (23), and in particular the pore cavities (36), are seeded electrolytically with coating material, in a second stage by current-free chemical deposition the pore cavities (36) are completely filled with coating material and the chemical deposition of coating material is continued until on the mould body surface (23) lying between the pore cavities (36) is formed a layer of 100 nm to 2 μm of coating material and in a third stage the coating is reinforced galvanically until a coating layer thickness of 10 to 20 μm is formed.

13. Process according to any of claims 7 to 12, characterised in that gold or silver is selected as a coating material.

14. Process according to any of claims 7 to 13, characterised that the removal of the mould body (22) to be performed in the third process step takes place by chemical etching of the mould layer (26).

15. Process according to any of claims 7 to 13, characterised in that the removal of the mould body (22) to be performed in the third process step takes place in two stages, where firstly the entire substrate body (24) is chemically etched away and in a second stage at least part of the mould layer (26) is removed by chemical etching or plasma etching.

16. Process according to any of claims 7 to 15, characterised in that the nanobodies (14), by secondary treatment by means of chemical or electrolytic etching or by plasma etching or by deposition of an additional thin layer, in particular of gold or silver, are optimised with regard to their surface-enhancing properties for Raman spectrometry.
